(19) United States
(12) Patent Application Publication
(10) Pub. No.: US 2026/0184957 A1
(43) Pub. Date: Jul. 2, 2026

(54) POLYURETHANE-CERAMIC COMPOSITE COATING AND SPRAYING METHOD

(71) Applicants: HUANENG NEW ENERGY CO., LTD. MENGXI BRANCH, Huhhot, Inner Mongolia (CN); XI'AN THERMAL POWER RESEARCH INSTITUTE CO., LTD., Xi'an, Shaanxi (CN)

(72) Inventors: Zhongxu GUO, Huhhot (CN); Fengwei ZHAO, Huhhot (CN); Song YANG, Huhhot (CN); Zhiyuan ZHAO, Huhhot (CN); Weizhong YAN, Huhhot (CN); Xiang SHI, Huhhot (CN); Zhinan LI, Huhhot (CN); Yajun LI, Huhhot (CN); Ruizhong TIAN, Huhhot (CN); Jing LIANG, Huhhot (CN); Guangwen CHENG, Huhhot (CN)

(73) Assignees: HUANENG NEW ENERGY CO., LTD. MENGXI BRANCH, Huhhot, Inner Mongolia (CN); XI'AN THERMAL POWER RESEARCH INSTITUTE CO., LTD., Xi'an, Shaanxi (CN)

(21) Appl. No.: 18/858,681

(22) PCT Filed: Sep. 20, 2024
(86) PCT No.: PCT/CN2024/120083

§ 371 Date: Oct. 21, 2024

(30) Foreign Application Priority Data
Aug. 28, 2023 (CN) 202311090244.9

(51) Int. Cl. C09D 175/12; C09D 7/40; C09D 7/61; C09D 7/63; C09D 183/06; F03D 1/06

(52) U.S. Cl. CPC C09D 175/12; C09D 7/61; C09D 7/63; C09D 7/67; C09D 183/06; F03D 1/0688; F05B 2230/90; F05B 2280/6003; F05B 2280/6011

(57) ABSTRACT

The present application discloses a polyurethane-ceramic composite coating and a spraying method. The coating includes two base materials, namely, a bottom layer and a surface layer. The bottom layer is arranged on a surface of a wind power blade and is a polyurethane base material, and the surface layer is arranged on the bottom layer and is a ceramic base material. A middle layer, namely, the polyurethane-ceramic composite coating, is formed between the surface layer and the bottom layer, serves as an adhesive for the bottom layer and the surface layer and can bond the bottom layer and the surface layer more tightly. As ceramic has characteristics of being water-proof, alcohol-resistant, wear-proof, scratch-resistant and high temperature resistant, a strength of a surface coating of the wind power blade is improved, an effect on protecting the polyurethane base material of the bottom layer is achieved, and a service life of the polyurethane base material is prolonged. The polyurethane-ceramic composite paint is sprayed to the wind power blade, so a service life of the wind power blade is prolonged.

### CROSS-REFERENCE TO RELATED APPLICATIONS

The present application claims priority to Chinese Patent Application No. 202311090244.9, filed to the China Patent Office on Aug. 28, 2023 and entitled “POLYURETHANE-CERAMIC COMPOSITE COATING AND SPRAYING METHOD”, the entire content of which is incorporated herein by reference.

### TECHNICAL FIELD

The present application belongs to the technical field of wind power generation and relates to a polyurethane-ceramic composite coating and a spraying method.

### BACKGROUND

A wind power generator is usually installed in a remote area where an operating environment is harsh, blades serve as the unique member for capturing wind energy, and a leading edge of each blade is a part of the wind power blade most susceptible to corrosion due to long-term wind friction and impact from sand grains, salt mist and rainwater. Especially, a leading edge of a blade tip of each blade is most severely corroded in the whole blade due to its thinness and a high linear velocity of running of the blade tip. After the leading edge of the wind power blade is corroded, an aerodynamic configuration of the wind power blade will be affected, so a power generation capacity of the wind power generator is reduced. If the issue of corrosion of the leading edge of the blade is not solved in time, more serious damages may occur to the blade over time, and thus hidden dangers are brought to safe running of the wind power generator. Thus, protection for the leading edge is a major challenge in the development of large blades.

At present, anticorrosive paint commonly used for a surface layer of the wind power generator includes polyurethane paint, fluorocarbon paint, polysiloxane paint and the like. The polyurethane paint has advantages of long mixed service life, fast surface drying and the like, which represents a development direction of the wind power paint. However, the polyurethane paint has drawbacks such as low impact resistance, low compressive strength, poor resistance to rain corrosion, poor resistance to high and low temperature and poor weather resistance, and in a wind field under harsh conditions, a protective material for the leading edge of the blade may have a failure after 3 to 5 years, which leads to corrosion of the leading edge. Thus, to develop a protective material for the leading edge which is highly protective, capable of decomposing rainwater impact stress and weather-proof is a problem urgent to be solved at present.

### SUMMARY OF THE INVENTION

An objective of the present application is to overcome the drawbacks in the prior art and provide a polyurethane-ceramic composite coating and a spraying method, so as to solve the problem that in the prior art, a polyurethane coating is poor in resistance to rainwater corrosion, resistance to high and low temperature and resistance to weather and a leading edge of a blade is prone to being corroded.

In order to achieve the above objective, the present application is implemented by adopting the following technical solutions.

A polyurethane-ceramic composite coating includes a bottom layer, a middle layer and a surface layer, the bottom layer is arranged on an outer surface of a wind power blade, the middle layer is arranged on an outer surface of the bottom layer, and the surface layer is arranged on an outer surface of the middle layer; the bottom layer is a polyurethane base material, the surface layer is a ceramic base material, and the middle layer is polyurethane-ceramic paint;
the polyurethane base material is composed of, by mass, 20% to 25% of diisocyanate, 15% to 20% of polyether glycol, 2.5% to 7.5% of a post chain extender, 1% to 2% of a hydrophilic chain extender, 1% to 3.5% of a first catalyst, 0.5% to 2% of a neutralizer and 50% of a solvent;
the ceramic base material is composed of a multifunctional silane coupling agent, multifunctional organic silicon resin, and a functional filler and an additive in a mass ratio of 1:1:1.5, and 0.1% to 0.2% of second catalyst by mass is further added;
the polyurethane-ceramic paint is obtained by mixing the polyurethane base material and the ceramic base material according to (1-1.5):1; and
the surface layer is of a three-dimensional network crosslinking structure, the functional filler and the additive are distributed in the three-dimensional network crosslinking structure, a part of the three-dimensional network crosslinking structure is generated spontaneously from the multifunctional silane coupling agent, and the other part of the three-dimensional network crosslinking structure is generated by a reaction of the multifunctional organic silicon resin and the multifunctional silane coupling agent.

A further improvement of the present application is:
optionally, the diisocyanate is one of isophorone diisocyanate, hexamethylene diisocyanate and 4,4′-dicyclohexylmethane diisocyanate, or any combination thereof; and
the polyether glycol is one of polytetrahydrofuran glycol (PTMG), polyethylene glycol and polypropylene glycol, or any combination thereof.

Optionally, the post chain extender is N-[(2-amino)-amino] sodium ethanesulfonate; and the hydrophilic chain extender is one of 2,2-dimethylolpropionic acid and dimethylolbutyric acid, or their combination.

Optionally, the catalyst is one of dibutyltin dilaurate, stannous octoate and dibutyltin oxide, or any combination thereof; the neutralizer is one of triethylamine, tripropylamine, formic acid, acetic acid and triethanolamine, or any combination thereof; and the solvent is N,N-dimethylformamide.

Optionally, the multifunctional silane coupling agent is triethoxysilane, and the multifunctional organic silicon resin is ethoxy phenyl silicon resin.

Optionally, the functional filler and the additive are composed of nanometer titanium dioxide, acrylate and organic amine; and the second catalyst is composed of octamethylcyclotetrasiloxane and potassium hydroxide in a volume part ratio of 100:(0.2-0.3).

Optionally, the bottom layer has a thickness ranging from 125 μm to 175 μm, the middle layer has a thickness ranging from 100 μm to 120 μm, and the surface layer has a thickness ranging from 120 μm to 135 μm.

A method for spraying the polyurethane-ceramic composite coating is characterized in that a polyurethane base material is blade-coated to a surface of a base material of a wind power blade, cured at 80° C. for 18 h and then cooled to obtain a bottom layer; polyurethane-ceramic paint is blade-coated to the bottom layer, cured at 80° C. for 18 h and then cooled to obtain a middle layer; and a ceramic base material is blade-coated to the middle layer, cured at 50° C. for 10 h and then cooled to obtain a surface layer.

Optionally, a process for preparing the polyurethane base material includes the following steps:
(1) weighing diisocyanate, polyether glycol, a post chain extender, a hydrophilic chain extender, a catalyst, a neutralizer and a solvent; and
(2) drying the polyether glycol and then putting the same in a container, feeding nitrogen into the container and performing stirring, then adding the catalyst and the diisocyanate, and performing heating and stirring; then adding the hydrophilic chain extender and performing a stirring reaction, cooling a reaction system, then adding the neutralizer for a neutralization reaction, cooling a product obtained after the neutralization reaction, then adding the post chain extender and the solvent, and performing stirring to obtain the polyurethane base material.

Optionally, a process for preparing the ceramic base material includes the following steps:
putting 100 parts of octamethylcyclotetrasiloxane in a container, adding 0.2 part to 0.3 part of potassium hydroxide into the container, performing heating and stirring to obtain transparent potassium hydroxide alkali gum so as to obtain a second catalyst; and
mixing and stirring a multifunctional silane coupling agent, N,N-dimethylformamide and the second catalyst, then adding multifunctional organic silicon resin, performing stirring, then adding a functional filler and an additive, and performing stirring to obtain the ceramic base material.

Compared with the prior art, the present application has the following beneficial effects.

The present application discloses a polyurethane-ceramic composite coating, the coating includes three base materials, namely, the bottom layer, the middle layer and the surface layer, the bottom layer is arranged on a surface of the wind power blade and is the polyurethane base material; the middle layer is the polyurethane-ceramic composite paint and arranged on the bottom later; and the surface layer is arranged on the middle layer and is the ceramic base material. The middle layer, namely, the polyurethane-ceramic composite coating, is formed between the surface layer and the bottom layer, serves as an adhesive for the bottom layer and the surface layer and can bond the bottom layer and the surface layer more tightly. The polyurethane base material of the bottom layer includes: diisocyanate, polyether glycol, a post chain extender, a hydrophilic chain extender, a catalyst, a neutralizer and a solvent. The hydrophilic chain extender makes the polyurethane base material have certain hydrophilicity, which plays a role in buffering and decomposing impact force of raindrops when the raindrops flush the surface of the wind power blade; and stability of polyurethane prepared by adding the post chain extender is high, emulsion dispersion is uniform, film formation is fast, and the rain erosion damage to a wetted surface can be effectively reduced. The ceramic base material of the surface layer is composed of three components: (1) the multifunctional silane coupling agent (component A) so that a sol-gel reaction occurs and the compact three-dimensional network crosslinking structure is formed; (2) the multifunctional organic silicon resin (component B) which can participate in the sol-gel reaction of the silane coupling agent so as to improve strength and toughness of the three-dimensional crosslinking structure; (3) the functional filler and the additive (component C) which includes (reinforcing, toughening, heat conducting, wear-resisting, ablation-resisting and the like) fillers, a flatting agent, a dispersing agent and the like; and (4) the second catalyst, namely, the potassium hydroxide alkali gum. As ceramic has characteristics of being water-proof, alcohol-resistant, wear-proof, scratch-resistant and high temperature resistant, a strength of a surface coating of the wind power blade is improved, an effect on protecting the polyurethane base material of the bottom layer is achieved, and a service life of the polyurethane base material is prolonged. The polyurethane-ceramic composite paint is sprayed onto the wind power blade, it may be observed through a scanning electron microscope that surface pores of a leading edge of the blade are reduced, and sizes of the pores are reduced remarkably. The ceramic has a large specific surface area so as to be boned to a polyurethane aggregate very tightly, the ceramic is used as a skeleton, the polyurethane may completely wrap and be boned to ceramic foam very tightly, and interface adhesion is good, so stress may be fully conducted to a substrate along the ceramic skeleton, a composite material is uniformly stressed in whole, and the resistance to rain erosion and impact of the leading edge of the wind power blade is improved.

The present application further discloses a method for preparing a polyurethane-ceramic composite coating. As polyaspartic acid polyurea quickly reacts with water, deionized water cannot be used as a solvent of the ceramic base material. The present application selects a polarity organic solvent N,N-dimethylformamide as the solvent, after the second catalyst is added, the sol-gel reaction in the ceramic base material may be facilitated, the compact three-dimensional network crosslinking structure is formed, and a stable state of the composite paint may be ensured. The ceramic is bonded to the polyurethane aggregate very tightly due to its special network structure and large specific surface area and is an ideal material for enhancing mechanical properties such as strength of the polyurethane composite material due to its light weight and good mechanical property, the spraying method is flexible and simple to operate, and scale production is allowed.

### DETAILED DESCRIPTION

One embodiment of the present application discloses a polyurethane-ceramic composite coating, the coating includes two base materials, namely, a bottom layer and a surface layer, where the bottom layer is arranged on a surface of a wind power blade and is a polyurethane base material; and the surface layer is arranged on the bottom layer and is a ceramic base material. The polyurethane base material of the bottom layer includes: diisocyanate, polyether glycol, a post chain extender, a hydrophilic chain extender, a first catalyst, a neutralizer and a solvent. The ceramic base material of the surface layer is composed of three components: (1) a multifunctional silane coupling agent (component A) so that a sol-gel reaction occurs and a compact three-dimensional network crosslinking structure is formed; (2) a multifunctional organic silicon resin (component B) which can participate in the sol-gel reaction of the silane coupling agent so as to improve strength and toughness of the three-dimensional network crosslinking structure; (3) a functional filler and an additive (component C) which includes (reinforcing, toughening, heat conducting, wear-resisting, ablation-resisting and the like) fillers, a flatting agent, a dispersing agent, a catalyst or a curing agent and the like; and (4) a second catalyst (component D).

Specifically, the diisocyanate is any one of isophorone diisocyanate, hexamethylene diisocyanate and 4,4′-dicyclohexylmethane diisocyanate, or any combination thereof, whose mass content is 20% to 25% of the polyurethane base material.

Specifically, the polyether glycol is one of polytetrahydrofuran glycol (PTMG), polyethylene glycol and polypropylene glycol, or any combination thereof, whose mass content is 15% to 20% of the polyurethane base material.

Specifically, the post chain extender is N-[(2-amino)-amino] sodium ethanesulfonate, whose mass content is 2.5% to 7.5% of the polyurethane base material.

Specifically, the hydrophilic chain extender is one of 2,2-dimethylolpropionic acid and dimethylolbutyric acid, or their combination, whose mass content is 1% to 2% of the polyurethane base material.

Specifically, the first catalyst is one type or several types of dibutyltin dilaurate, stannous octoate and dibutyltin oxide, whose mass content is 1% to 3.5% of the polyurethane base material.

Specifically, the neutralizer is one type or several types of triethylamine, tripropylamine, formic acid, acetic acid, and triethanolamine, whose mass content is 0.5% to 2% of the polyurethane base material.

Specifically, the solvent is N,N-dimethylformamide, whose mass content is 50% of the polyurethane base material.

Specifically, the ceramic base material is composed of four components: (component A) triethoxysilane; (component B) ethoxyphenyl silicon resin; (component C) including nanometer titanium dioxide, acrylate and organic amine, where the nanometer titanium dioxide is the enhancing filler, the acrylate is the flatting agent, and the organic amine is a pH regulator, and a mass ratio of the three in the ceramic is 1:1:1.5. The component D is the second catalyst and includes octamethylcyclotetrasiloxane and potassium hydroxide, and a mass content of the catalyst is 0.1% to 0.2% in the ceramic.

Another embodiment of the present application discloses a method for preparing and spraying a polyurethane-ceramic composite coating, including the following steps:
(1) diisocyanate, polyether glycol, a post chain extender, a hydrophilic chain extender, a first catalyst, a neutralizer and a solvent are weighed respectively according to a set mass ratio;
(2) the weighed polyether glycol is dried for 5 h at 110° C.;
(3) the polyether glycol dried in step (2) is taken out and added into a three-neck round-bottom flask, nitrogen is fed into the flask, and stirring starts to be performed for 20 min at 350 r/min;
(4) the weighed first catalyst and diisocyanate are added into the flask of step (3), and stirring starts to be performed for 30 min to 60 min at 350 r/min and 88° C.;
(5) the weighed hydrophilic chain extender is added into the flask of step (4), and stirring starts to be performed for 2 h to 3 h at 350 r/min and 80° C.;
(6) a reaction product of step (5) is cooled to 50° C., the weighed neutralizer is added for a neutralization reaction for 30 min to 40 min;
(7) the reaction product of step (6) is cooled to 35° C., the weighed post chain extender and solvent are added, stirring starts to be performed for 30 min to 40 min at 900 r/min, and finally the polyurethane base material of the bottom layer is obtained;
(8) the polyurethane base material of the bottom layer is blade-coated to a surface of a base material of the wind power blade, cured for 18 h at 80° C. and cooled to obtain the polyurethane base material bottom layer, which has a thickness in a range from 125 μm to 175 μm;
(9) 100 parts of octamethylcyclotetrasiloxane are put in a flask, the flask is put in an oil bath pan; and 0.2 part to 0.3 part of potassium hydroxide is slowly added into the flask through a funnel, stirring starts to be performed, heating is performed to be in a range from 115° C. to 120° C., and after the potassium hydroxide is dissolved completely, cooling is performed to reach a room temperature to obtain transparent potassium hydroxide alkali gum, namely, the catalyst component D;
(10) components A, B and C of the ceramic are weighed respectively and have a mass ratio 1:1:1.5 in the ceramic, and the catalyst component D in step (8) is weighed and has a mass content in a range from 0.1% to 0.2%;
(11) the component A, namely, the triethoxysilane, N,N-dimethylformamide and the component D, namely, the catalyst are put in a 50° C. water bath kettle for stirring for 0.5 h to 1 h at a stirring speed ranging from 100 r/min to 180 r/min;
(12) the component B, namely, ethoxy phenyl silicon resin is added into a reaction product of step (11), and stirring is performed for 2 h to 2.5 h at a normal temperature and at a stirring speed ranging from 400 r/min to 560 r/min;
(13) nanometer titanium dioxide, acrylate and organic amine in the component C are added into a reaction product of step (12), and stirring is performed for 1 h to 1.5 h at a normal temperature and at a stirring speed ranging from 400 r/min to 500 r/min to obtain the ceramic base material of the surface layer;
(14) the polyurethane base material in step (7) and the ceramic base material in step (13) are weighed according to a mass ratio (1 to 1.5):1 and are fully stirred for 2 h to 2.5 h at a normal temperature and at a stirring speed ranging from 100 r/min to 180 r/min to obtain polyurethane-ceramic paint;
(15) the polyurethane-ceramic base material is blade-coated to a surface of the polyurethane bottom layer, cured for 18 h at 80° C. and cooled to obtain a polyurethane-ceramic base material middle layer, which has a thickness in a range from 100 μm to 120 μm; and
(16) the ceramic base material is blade-coated to a surface of the polyurethane-ceramic middle layer, cured for 10 h at 50° C. and cooled to obtain the ceramic surface layer, which has a thickness in a range from 120 μm to 135 μm.

A further description is made below with reference to specific embodiments.

### Embodiment 1

(1) Isophorone diisocyanate (IPDI), polytetrahydrofuran glycol (PTMG), 2,2-dimethylolpropionic acid (DMPA), triethylamine (TEA), dibutyltin dilaurate (DBTDL), N-[(2-amino)-amino] sodium ethanesulfonate (AAS) and N,N-dimethylformamide are weighed respectively according to the above proportion; and a mass content of each substance is: 22%, 20%, 1%, 0.5%, 2% and 4.5% respectively.
(2) The weighed polytetrahydrofuran glycol is dried for 5 h at 110° C.
(3) The polytetrahydrofuran glycol dried in step (2) is taken out and added into a three-neck round-bottom flask, nitrogen is fed into the flask, and stirring starts to be performed for 20 min at 350 r/min.
(4) The weighed dibutyltin dilaurate (DBTDL) and isophorone diisocyanate (IPDI) are added into the flask of step (3), and stirring starts to be performed for 30 min to 60 min at 350 r/min and 88° C.
(5) The weighed 2,2-dimethylolpropionic acid (DMPA) is added into the flask of step (4), and stirring starts to be performed for 2 h to 3 h at 350 r/min and 80° C.
(6) A reaction product of step (5) is cooled to 50° C., and the weighed triethylamine (TEA) is added for a neutralization reaction for 30 min to 40 min.
(7) A reaction product of step (6) is cooled to 35° C., the weighed N-[(2-amino)-amino] sodium ethanesulfonate (AAS) and N,N-dimethylformamide are added, stirring starts to be performed for 30 min to 40 min at 900 r/min, and finally, the polyurethane base material of the bottom layer is obtained.
(8) The polyurethane base material of the bottom layer is blade-coated to a surface of a base material of the wind power blade, cured for 18 h at 80° C. and cooled to obtain the polyurethane base material bottom layer, which has a thickness of 125 μm.
(9) 100 parts, by mass, of octamethylcyclotetrasiloxane are put in a flask, the flask is put in an oil bath pan; and 0.2 part of potassium hydroxide is slowly added into the flask through a funnel, stirring starts to be performed, heating is performed to reach 115° C., and after the potassium hydroxide is dissolved completely, cooling is performed to reach a room temperature to obtain transparent potassium hydroxide alkali gum, namely, the catalyst component D.
(10) Components A, B and C of the ceramic are weighed respectively and have a mass ratio 1:1:1.5 in the ceramic. The catalyst component D in step (8) is weighed and has a mass content of 0.1%.
(11) The component A, namely, triethoxysilane, N,N-dimethylformamide and the component D, namely, the catalyst are put in a 50° C. water bath kettle for stirring for 0.5 h at a stirring speed of 100 r/min.
(12) The component B, namely, ethoxy phenyl silicon resin is added into a reaction product of step (11), and stirring is performed for 2 h at a normal temperature and at a stirring speed of 400 r/min.
(13) Nanometer titanium dioxide, acrylate and organic amine in the component C are added into a reaction product of step (12), and stirring is performed for 1 h at a normal temperature and at a stirring speed of 400 r/min to obtain the ceramic base material of the surface layer.
(14) The polyurethane base material in step (7) and the ceramic base material in step (13) are weighed according to a mass ratio (1:1) and are fully stirred for 2 h at a normal temperature and at a stirring speed of 100 r/min to obtain polyurethane-ceramic paint.
(15) The polyurethane-ceramic base material is blade-coated to a surface of the polyurethane bottom layer, cured for 18 h at 80° C. and cooled to obtain a polyurethane-ceramic base material middle layer, which has a thickness of 100 μm.
(16) The ceramic base material is blade-coated to a surface of the polyurethane-ceramic middle layer, cured for 10 h at 50° C. and cooled to obtain the ceramic surface layer, which has a thickness of 120 μm.

### Embodiment 2

(1) Hexamethylene diisocyanate, polytetrahydrofuran glycol (PTMG), 2,2-dimethylolpropionic acid (DMPA), tripropylamine, dibutyltin dilaurate (DBTDL), N-[(2-amino)-amino] sodium ethanesulfonate (AAS) and N,N-dimethylformamide are weighed respectively, and a mass content of each substance is: 20%, 15%, 2%, 2%, 3.5%, 7.5% and 50% respectively.
(2) The weighed polytetrahydrofuran glycol is dried for 5 h at 110° C.
(3) The polytetrahydrofuran glycol dried in step (2) is taken out and added into a three-neck round-bottom flask, nitrogen is fed into the flask, and stirring starts to be performed for 20 min at 350 r/min.
(4) The weighed dibutyltin dilaurate (DBTDL) and isophorone diisocyanate (IPDI) are added into the flask of step (3), and stirring starts to be performed for 60 min at 350 r/min and 88° C.
(5) The weighed 2,2-dimethylolpropionic acid (DMPA) is added into the flask of step (4), and stirring starts to be performed for 3 h at 350 r/min and 80° C.
(6) A reaction product of step (5) is cooled to 50° C., and the weighed triethylamine (TEA) is added for a neutralization reaction for 40 min.
(7) A reaction product of step (6) is cooled to 35° C., the weighed N-[(2-amino)-amino] sodium ethanesulfonate (AAS) and N,N-dimethylformamide are added, stirring starts to be performed for 40 min at 900 r/min, and finally, the polyurethane base material of the bottom layer is obtained.
(8) The polyurethane base material of the bottom layer is blade-coated to a surface of a base material of the wind power blade, cured for 18 h at 80° C. and cooled to obtain the polyurethane base material bottom layer, which has a thickness of 175 μm.
(9) 100 parts of octamethylcyclotetrasiloxane are put in a flask, the flask is put in an oil bath pan; and 0.3 part of potassium hydroxide is slowly added into the flask through a funnel, stirring starts to be performed, heating is performed to reach 120° C., and after the potassium hydroxide is dissolved completely, cooling is performed to reach a room temperature to obtain transparent potassium hydroxide alkali gum, namely, the catalyst component D.
(10) Components A, B and C of the ceramic are weighed respectively and have a mass ratio 1:1:1.5 in the ceramic. The catalyst component D in step (8) is weighed and has a mass content of 0.2%.
(11) The component A, namely, triethoxysilane, N,N-dimethylformamide and the component D, namely, the catalyst are put in a 50° C. water bath kettle for stirring for 1 h at a stirring speed of 180 r/min.
(12) The component B, namely, ethoxy phenyl silicon resin is added into a reaction product of step (11), and stirring is performed for 2.5 h at a normal temperature and at a stirring speed of 560 r/min.
(13) Nanometer titanium dioxide, acrylate and organic amine in the component C are added into a reaction product of step (12), and stirring is performed for 1.5 h at a normal temperature and at a stirring speed of 500 r/min to obtain the ceramic base material of the surface layer.
(14) The polyurethane base material in step (7) and the ceramic base material in step (13) are weighed according to a mass ratio (1.5:1) and are fully stirred for 2.5 h at a normal temperature and at a stirring speed of 180 r/min to obtain polyurethane-ceramic paint.
(15) The polyurethane-ceramic base material is blade-coated to a surface of the polyurethane bottom layer, cured for 18 h at 80° C. and cooled to obtain a polyurethane-ceramic base material middle layer, which has a thickness of 120 μm.
(16) The ceramic base material is blade-coated to a surface of the polyurethane-ceramic middle layer, cured for 10 h at 50° C. and cooled to obtain the ceramic surface layer, which has a thickness of 135 μm.

### Embodiment 3

(1) 4,4′-dicyclohexylmethane diisocyanate, polyethylene glycol, 2,2-dimethylolpropionic acid (DMPA), formic acid, dibutyltin dilaurate (DBTDL), N-[(2-amino)-amino] sodium ethanesulfonate (AAS) and N,N-dimethylformamide are weighed respectively, and a mass content of each substance is: 25%, 18%, 1.5%, 1%, 1%, 3.5% and 50% respectively.
(2) The weighed polytetrahydrofuran glycol is dried for 5 h at 110° C.
(3) The polytetrahydrofuran glycol dried in step (2) is taken out and added into a three-neck round-bottom flask, nitrogen is fed into the flask, and stirring starts to be performed for 20 min at 350 r/min.
(4) The weighed dibutyltin dilaurate (DBTDL) and isophorone diisocyanate (IPDI) are added into the flask of step (3), and stirring starts to be performed for 60 min at 350 r/min and 88° C.
(5) The weighed 2,2-dimethylolpropionic acid (DMPA) is added into the flask of step (4), and stirring starts to be performed for 3 h at 350 r/min and 80° C.
(6) A reaction product of step (5) is cooled to 50° C., and the weighed triethylamine (TEA) is added for a neutralization reaction for 40 min.
(7) A reaction product of step (6) is cooled to 35° C., the weighed N-[(2-amino)-amino] sodium ethanesulfonate (AAS) and N,N-dimethylformamide are added, stirring starts to be performed for 40 min at 900 r/min, and finally, the polyurethane base material of the bottom layer is obtained.
(8) The polyurethane base material of the bottom layer is blade-coated to a surface of a base material of the wind power blade, cured for 18 h at 80° C. and cooled to obtain the polyurethane base material bottom layer, which has a thickness of 155 μm.
(9) 100 parts of octamethylcyclotetrasiloxane are put in a flask, the flask is put in an oil bath pan; and 0.3 part of potassium hydroxide is slowly added into the flask through a funnel, stirring starts to be performed, heating is performed to reach 120° C., and after the potassium hydroxide is dissolved completely, cooling is performed to reach a room temperature to obtain transparent potassium hydroxide alkali gum, namely, the catalyst component D.
(10) Components A, B and C of the ceramic are weighed respectively and have a mass ratio 1:1:1.5 in the ceramic. The catalyst component D in step (8) is weighed and has a mass content of 0.15%.
(11) The component A, namely, triethoxysilane, N,N-dimethylformamide and the component D, namely, the catalyst are put in a 50° C. water bath kettle for stirring for 1 h at a stirring speed of 180 r/min.
(12) The component B, namely, ethoxy phenyl silicon resin is added into a reaction product of step (11), and stirring is performed for 2.5 h at a normal temperature and at a stirring speed of 560 r/min.
(13) Nanometer titanium dioxide, acrylate and organic amine in the component C are added into a reaction product of step (12), and stirring is performed for 1.5 h at a normal temperature and at a stirring speed of 500 r/min to obtain the ceramic base material of the surface layer.
(14) The polyurethane base material in step (7) and the ceramic base material in step (13) are weighed according to a mass ratio (1.5:1) and are fully stirred for 2.5 h at a normal temperature and at a stirring speed of 180 r/min to obtain polyurethane-ceramic paint.
(15) The polyurethane-ceramic base material is blade-coated to a surface of the polyurethane bottom layer, cured for 18 h at 80° C. and cooled to obtain a polyurethane-ceramic base material middle layer, which has a thickness of 110 82 m.
(16) The ceramic base material is blade-coated to a surface of the polyurethane-ceramic middle layer, cured for 10 h at 50° C. and cooled to obtain the ceramic surface layer, which has a thickness of 125 μm.

### Embodiment 4

(1) Isophorone diisocyanate (IPDI), polypropylene glycol, dimethylolbutyric acid, acetic acid, dibutyltin dilaurate (DBTDL), N-[(2-amino)-amino] sodium ethanesulfonate (AAS) and N,N-dimethylformamide are weighed respectively, and a mass content of each substance is: 23%, 20%, 2%, 0.5%, 2%, 2.5% and 50% respectively.
(2) The weighed polytetrahydrofuran glycol is dried for 5 h at 110° C.
(3) The polytetrahydrofuran glycol dried in step (2) is taken out and added into a three-neck round-bottom flask, nitrogen is fed into the flask, and stirring starts to be performed for 20 min at 350 r/min.
(4) The weighed dibutyltin dilaurate (DBTDL) and isophorone diisocyanate (IPDI) are added into the flask of step (3), and stirring starts to be performed for 60 min at 350 r/min and 88° C.
(5) The weighed 2,2-dimethylolpropionic acid (DMPA) is added into the flask of step (4), and stirring starts to be performed for 3 h at 350 r/min and 80° C.
(6) A reaction product of step (5) is cooled to 50° C., and the weighed triethylamine (TEA) is added for a neutralization reaction for 40 min.
(7) A reaction product of step (6) is cooled to 35° C., the weighed N-[(2-amino)-amino] sodium ethanesulfonate (AAS) and N,N-dimethylformamide are added, stirring starts to be performed for 40 min at 900 r/min, and finally, the polyurethane base material of the bottom layer is obtained.
(8) The polyurethane base material of the bottom layer is blade-coated to a surface of a base material of the wind power blade, cured for 18 h at 80° C. and cooled to obtain the polyurethane base material bottom layer, which has a thickness of 145 μm.
(9) 100 parts of octamethylcyclotetrasiloxane are put in a flask, the flask is put in an oil bath pan; and 0.3 part of potassium hydroxide is slowly added into the flask through a funnel, stirring starts to be performed, heating is performed to reach 120° C., and after the potassium hydroxide is dissolved completely, cooling is performed to reach a room temperature to obtain transparent potassium hydroxide alkali gum, namely, the catalyst component D.
(10) Components A, B and C of the ceramic are weighed respectively and have a mass ratio 1:1:1.5 in the ceramic. The catalyst component D in step (8) is weighed and has a mass content of 0.2%.
(11) The component A, namely, triethoxysilane, N,N-dimethylformamide and the component D, namely, the catalyst are put in a 50° C. water bath kettle for stirring for 1 h at a stirring speed of 180 r/min.
(12) The component B, namely, ethoxy phenyl silicon resin is added into a reaction product of step (11), and stirring is performed for 2.5 h at a normal temperature and at a stirring speed of 560 r/min.
(13) Nanometer titanium dioxide, acrylate and organic amine in the component C are added into a reaction product of step (12), and stirring is performed for 1.5 h at a normal temperature and at a stirring speed of 500 r/min to obtain the ceramic base material of the surface layer.
(14) The polyurethane base material in step (7) and the ceramic base material in step (13) are weighed according to a mass ratio (1.5:1) and are fully stirred for 2.5 h at a normal temperature and at a stirring speed of 180 r/min to obtain polyurethane-ceramic paint.
(15) The polyurethane-ceramic base material is blade-coated to a surface of the polyurethane bottom layer, cured for 18h at 80° C. and cooled to obtain a polyurethane-ceramic base material middle layer, which has a thickness of 105 μm.
(16) The ceramic base material is blade-coated to a surface of the polyurethane-ceramic middle layer, cured for 10 h at 50° C. and cooled to obtain the ceramic surface layer, which has a thickness of 125 μm.

### Embodiment 5

(1) Isophorone diisocyanate (IPDI), polytetrahydrofuran glycol (PTMG), 2,2-dimethylolpropionic acid (DMPA), triethanolamine, dibutyltin dilaurate (DBTDL), N-[(2-amino)-amino] sodium ethanesulfonate (AAS) and N,N-dimethylformamide are weighed respectively, and a mass content of each substance is: 21%, 17%, 1.5%, 1.5%, 3.5%, 5.5% and 50% respectively.
(2) The weighed polytetrahydrofuran glycol is dried for 5 h at 110° C.
(3) The polytetrahydrofuran glycol dried in step (2) is taken out and added into a three-neck round-bottom flask, nitrogen is fed into the flask, and stirring starts to be performed for 20 min at 350 r/min.
(4) The weighed dibutyltin dilaurate (DBTDL) and isophorone diisocyanate (IPDI) are added into the flask of step (3), and stirring starts to be performed for 60 min at 350 r/min and 88° C.
(5) The weighed 2,2-dimethylolpropionic acid (DMPA) is added into the flask of step (4), and stirring starts to be performed for 3 h at 350 r/min and 80° C.
(6) A reaction product of step (5) is cooled to 50° C., and the weighed triethylamine (TEA) is added for a neutralization reaction for 40 min.
(7) A reaction product of step (6) is cooled to 35° C., the weighed N-[(2-amino)-amino] sodium ethanesulfonate (AAS) and N,N-dimethylformamide are added, stirring starts to be performed for 40 min at 900 r/min, and finally, the polyurethane base material of the bottom layer is obtained.
(8) The polyurethane base material of the bottom layer is blade-coated to a surface of a base material of the wind power blade, cured for 18 h at 80° C. and cooled to obtain the polyurethane base material bottom layer, which has a thickness of 175 μm.
(9) 100 parts of octamethylcyclotetrasiloxane are put in a flask, the flask is put in an oil bath pan; and 0.3 part of potassium hydroxide is slowly added into the flask through a funnel, stirring starts to be performed, heating is performed to reach 120° C., and after the potassium hydroxide is dissolved completely, cooling is performed to reach a room temperature to obtain transparent potassium hydroxide alkali gum, namely, the catalyst component D.
(10) Components A, B and C of the ceramic are weighed respectively and have a mass ratio 1:1:1.5 in the ceramic. The catalyst component D in step (8) is weighed and has a mass content of 0.2%.
(11) The component A, namely, triethoxysilane, N,N-dimethylformamide and the component D, namely, the catalyst are put in a 50° C. water bath kettle for stirring for 1 h at a stirring speed of 180 r/min.
(12) The component B, namely, ethoxy phenyl silicon resin is added into a reaction product of step (11), and stirring is performed for 2.5 h at a normal temperature and at a stirring speed of 560 r/min.
(13) Nanometer titanium dioxide, acrylate and organic amine in the component C are added into a reaction product of step (12), and stirring is performed for 1.5 h at a normal temperature and at a stirring speed of 500 r/min to obtain the ceramic base material of the surface layer. The polyurethane base material in step (7) and the ceramic base material in step (13) are weighed according to a mass ratio (1.5:1) and are fully stirred for 2.5 h at a normal temperature and at a stirring speed of 180 r/min to obtain polyurethane-ceramic paint.
(14) The polyurethane-ceramic base material is blade-coated to a surface of the polyurethane bottom layer, cured for 18 h at 80° C. and cooled to obtain a polyurethane-ceramic base material middle layer, which has a thickness of 120 μm.
(15) The ceramic base material is blade-coated to a surface of the polyurethane-ceramic middle layer, cured for 10 h at 50° C. and cooled to obtain the ceramic surface layer, which has a thickness of 135 μm.

The foregoing descriptions are merely preferable embodiments of the present application, but are not intended to limit the present application. Any modification, equivalent replacement, or improvement made within the spirit and principle of the present application is supposed to fall within the protection scope of the present application.

1. A polyurethane-ceramic composite coating, comprising a bottom layer, a middle layer and a surface layer, wherein the bottom layer is arranged on an outer surface of a wind power blade, the middle layer is arranged on an outer surface of the bottom layer, and the surface layer is arranged on an outer surface of the middle layer; the bottom layer is a polyurethane base material, the surface layer is a ceramic base material, and the middle layer is polyurethane-ceramic paint;
the polyurethane base material is composed of, by mass, 20% to 25% of diisocyanate, 15% to 20% of polyether glycol, 2.5% to 7.5% of a post chain extender, 1% to 2% of a hydrophilic chain extender, 1% to 3.5% of a first catalyst, 0.5% to 2% of a neutralizer and 50% of a solvent;
the ceramic base material is composed of a multifunctional silane coupling agent, multifunctional organic silicon resin, and a functional filler and an additive in a mass ratio of 1:1:1.5, and 0.1% to 0.2% of second catalyst by mass is further added;
the polyurethane-ceramic paint is obtained by mixing the polyurethane base material and the ceramic base material according to (1-1.5):1; and
the surface layer is of a three-dimensional network crosslinking structure, the functional filler and the additive are distributed in the three-dimensional network crosslinking structure, a part of the three-dimensional network crosslinking structure is generated spontaneously from the multifunctional silane coupling agent, and the other part of the three-dimensional network crosslinking structure is generated by a reaction of the multifunctional organic silicon resin and the multifunctional silane coupling agent.

2. The polyurethane-ceramic composite coating according to claim 1, wherein the diisocyanate is one of isophorone diisocyanate, hexamethylene diisocyanate and 4,4′-dicyclohexylmethane diisocyanate, or any combination thereof; and
the polyether glycol is one of polytetrahydrofuran glycol (PTMG), polyethylene glycol and polypropylene glycol, or any combination thereof.

3. The polyurethane-ceramic composite coating according to claim 1, wherein the post chain extender is N-[(2-amino)-amino] sodium ethanesulfonate; and the hydrophilic chain extender is one of 2,2-dimethylolpropionic acid and dimethylolbutyric acid, or their combination.

4. The polyurethane-ceramic composite coating according to claim 1, wherein the catalyst is one of dibutyltin dilaurate, stannous octoate and dibutyltin oxide, or any combination thereof; the neutralizer is one of triethylamine, tripropylamine, formic acid, acetic acid and triethanolamine, or any combination thereof; and the solvent is N,N-dimethylformamide.

5. The polyurethane-ceramic composite coating according to claim 1, wherein the multifunctional silane coupling agent is triethoxysilane, and the multifunctional organic silicon resin is ethoxy phenyl silicon resin.

6. The polyurethane-ceramic composite coating according to claim 1, wherein the functional filler and the additive are composed of nanometer titanium dioxide, acrylate and organic amine; and the second catalyst is composed of octamethylcyclotetrasiloxane and potassium hydroxide in a volume part ratio of 100:(0.2-0.3).

7. The polyurethane-ceramic composite coating according to claim 1, wherein the bottom layer has a thickness ranging from 125 μm to 175 μm, the middle layer has a thickness ranging from 100 μm to 120 μm, and the surface layer has a thickness ranging from 120 μm to 135 μm.

8. A method for spraying the polyurethane-ceramic composite coating according to claim 1, wherein a polyurethane base material is blade-coated to a surface of a base material of a wind power blade, cured at 80° C. for 18 h and then cooled to obtain a bottom layer; polyurethane-ceramic paint is blade-coated to the bottom layer, cured at 80° C. for 18 h and then cooled to obtain a middle layer; and a ceramic base material is blade-coated to the middle layer, cured at 50° C. for 10 h and then cooled to obtain a surface layer.

9. The method for spraying the polyurethane-ceramic composite coating according to claim 8, wherein a process for preparing the polyurethane base material includes the following steps:
(1) weighing diisocyanate, polyether glycol, a post chain extender, a hydrophilic chain extender, a catalyst, a neutralizer and a solvent; and
(2) drying the polyether glycol and then putting the same in a container, feeding nitrogen into the container and performing stirring, then adding the catalyst and the diisocyanate, and performing heating and stirring; then adding the hydrophilic chain extender and performing a stirring reaction, cooling a reaction system, then adding the neutralizer for a neutralization reaction, cooling a product obtained after the neutralization reaction, then adding the post chain extender and the solvent, and performing stirring to obtain the polyurethane base material.

10. The method for spraying the polyurethane-ceramic composite coating according to claim 8, wherein a process for preparing the ceramic base material includes the following steps:
putting 100 parts of octamethylcyclotetrasiloxane in a container, adding 0.2 part to 0.3 part of potassium hydroxide into the container, performing heating and stirring to obtain transparent potassium hydroxide alkali gum so as to obtain a second catalyst; and
mixing and stirring a multifunctional silane coupling agent, N,N-dimethylformamide and the second catalyst, then adding multifunctional organic silicon resin, performing stirring, then adding a functional filler and an additive, and performing stirring to obtain the ceramic base material.
